(19) United States
(12) Patent Application Publication
(10) Pub. No.: US 2015/0154205 A1
(43) Pub. Date: Jun. 4, 2015

(54) System, Method and Computer-Accessible Medium for Clipping and Sharing Media

(71) Applicants: Joseph C. Grano, Marina Del Rey, CA (US); Samuel Jurist, Mendham, NJ (US); Jackie Tran Anh, Prague 2 (CZ)

(72) Inventors: Joseph C. Grano, Marina Del Rey, CA (US); Samuel Jurist, Mendham, NJ (US); Jackie Tran Anh, Prague 2 (CZ)

(73) Assignee: SNIPPIT MEDIA, INC., Marina Del Rey, CA (US)

(21) Appl. No.: 14/095,547

(22) Filed: Dec. 3, 2013

(51) Int. Cl. G06F 17/30; G06Q 30/02; G06Q 30/06

(52) U.S. Cl. CPC G06F 17/30064; G06Q 30/0633; G06Q 30/0214

(57) ABSTRACT

Systems, methods and computer-accessible media are provided for generating media clips that can receive first information related to media, second information related to a position of a window of time, and third information related to a further position of the window of time based on a movement of the window of time while maintaining the time interval. The window of time generally has a time interval with a preset maximum time. The media clip can be generated based on the second information and the third information. Information related to content can be received and combined with the media clip into a single digital file. Information about the media can be requested, and users can purchase the media from an online store. Revenue can be generated through a referral to the online store.

### FIELD OF THE DISCLOSURE

Exemplary embodiments of the present disclosure relate to systems, methods and computer-accessible media for clipping and sharing media, and more specifically, to exemplary systems, methods and computer-accessible media that can clip media, add additional content to the clipped media, and share the combination thereof.

### BACKGROUND INFORMATION

Online social networking services have emerged as large-scale environments for users to connect with other users and as platforms for users to share social media, such as Facebook® and Twitter®. For example, on Twitter, users can send and view tweets and follow other users. On Facebook, users can add other users as friends, and create and view posts or pictures by other users. However, both of these social network services can be limiting. For example, on Twitter, a tweet is limited to 140 characters, which may include a shortened hyperlink to a picture. On Facebook, users can only post text, pictures, or videos. Currently there is no social media platform, that allows a user to clip different media (e.g., music), combine the clipped media with various other types of content and share the combined content, or to convey an idea having different components (e.g., music, picture, text, location etc.).

Thus, it may be beneficial to provide exemplary systems, methods and computer-accessible media that can facilitate easy clipping of media and the ability to add additional content to the media, and enable users to share the combination with others, and that can overcome at least some of the deficiencies described herein above.

### SUMMARY OF EXEMPLARY EMBODIMENTS

Exemplary systems, methods and computer-accessible media for generating a media clip(s) can be provided, which can include receiving first information related to a media, receiving second information related to a position of a window of time in relation to the media, the window of time having a time interval with a preset maximum time, receiving third information related to a further position of the window of time based on a movement of the window of time while maintaining the time interval, and generating media clip(s) based on the second information and the third information.

In some exemplary embodiments, the preset maximum time is about 10 seconds. The media clip(s) can be generated by clipping the media based on the time interval and the further position of the window of time. The media can be an audio file or a video file. Information related to content(s) can be received and combined with the media clip(s) into a single digital file. The content(s) can include, without limitation, an image, a caption, a location, a tag of a user, an audio clip, and a video clip. The single digital file can be shared with a plurality of users. In certain exemplary embodiments, a request for information pertaining to the media clip(s) can be received and directed to online store(s) where the media can be purchased. A monetary credit can be received for directing the request to the at least one online store or if the media is purchased from the at least one online store.

In another exemplary embodiment of the present disclosure, exemplary systems, methods and computer-accessible media can be provided for clipping and sharing media, including receiving first information related to media, receiving second information related to a portion of the media, receiving third information related to content(s), generating a single digital file containing the second information and the third information, and sharing the single digital file with one or more users.

In another exemplary embodiment of the present disclosure, exemplary systems, methods and computer-accessible media can be provided for receiving a monetary credit, including receiving first information related to media, receiving second information related to a portion of the media, receiving a request for information pertaining to the portion of the media, directing the request to an online store(s) where the media can be purchased, and receiving a monetary credit from the online store(s).

These and other objects, features and advantages of the exemplary embodiment of the present disclosure will become apparent upon reading the following detailed description of the exemplary embodiments of the present disclosure, when taken in conjunction with the appended claims.

### BRIEF DESCRIPTIONS OF THE DRAWINGS

Further objects, features and advantages of the present disclosure will become apparent from the following detailed description taken in conjunction with the accompanying Figures showing illustrative embodiments of the present disclosure, in which:

FIG. 1A is an image of a home screen according to an exemplary embodiment of the present disclosure;

FIG. 1B is an image of a home screen according to another exemplary embodiment of the present disclosure;

FIG. 1C is an image of a menu of a home screen according to an exemplary embodiment of the present disclosure;

FIG. 2 is an image of an action screen according to an exemplary embodiment of the present disclosure;

FIG. 3A is an image of a portion of an explore screen according to an exemplary embodiment of the present disclosure;

FIG. 3B is an image of a portion df an explore screen according to an exemplary embodiment of the present disclosure;

FIG. 4A is an image of a profile screen according to an exemplary embodiment of the present disclosure;

FIG. 4B is an image of a profile screen according to another exemplary embodiment of the present disclosure;

FIG. 5A is an image of a create screen for clipping media according to an exemplary embodiment of the present disclosure;

FIG. 5B is an image of a create screen illustrating a play action in the window according to an exemplary embodiment of the present disclosure;

FIG. 5C is an image of a create screen illustrating a play action in the window and a capture of the media window in the insertion area according to an exemplary embodiment of the present disclosure;

FIG. 5D is an image of a create screen illustrating a play action in the capture according to an exemplary embodiment of the present disclosure;

FIG. 6A is an image of an add content screen for adding additional content to the media clip according to an exemplary embodiment of the present disclosure;

FIG. 6B is an image of an add content screen illustrating an image added to the media clip according to an exemplary embodiment of the present disclosure;

FIG. 7A is an image of a select media screen displaying media owned by a user according to an exemplary embodiment of the present disclosure;

FIG. 7B is an image of a select media screen displaying media available for purchase by a user according to an exemplary embodiment of the present disclosure;

FIG. 8 is an image of an information screen for displaying content information and a purchase link for purchasing a full version of the clipped media according to an exemplary embodiment of the present disclosure;

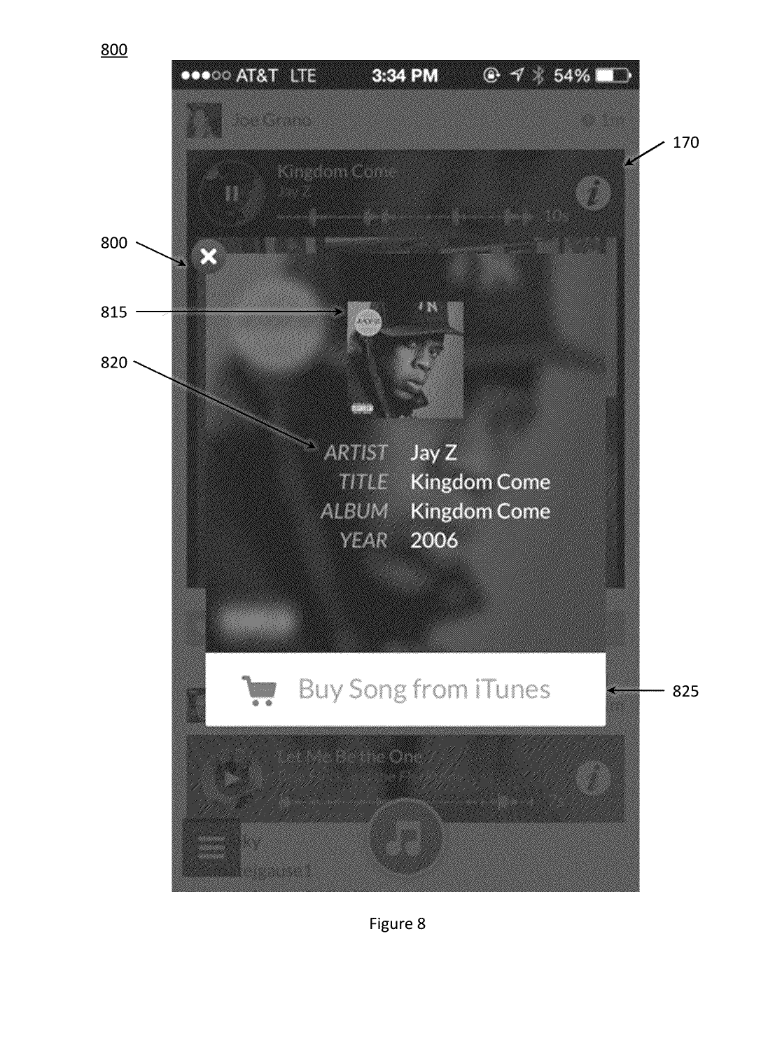

FIG. 9 is a flow chart for creating a Snip according to an exemplary embodiment of the present disclosure;

FIG. 10 is a flow chart for clipping media to be used in a Snip according to an exemplary embodiment of the present disclosure;

FIG. 11 is an illustration of a block diagram of a system in accordance with certain exemplary embodiments of the present disclosure; and

FIG. 12 is a flow chart of an exemplary implementation of aspects of the present disclosure.

Throughout the drawings, the same reference numerals and characters, unless otherwise stated, are used to denote like features, elements, components, or portions of the illustrated embodiments. Moreover, while the present disclosure will now be described in detail with reference to the figures, it is done so in connection with the illustrative embodiments and is not limited by the particular embodiments illustrated in the figures. It is intended that changes and modifications can be made to the described exemplary embodiments without departing from the true scope and spirit of the subject disclosure as defined by the appended claims.

### DETAILED DESCRIPTION OF EXEMPLARY EMBODIMENTS

The exemplary systems, methods and computer-accessible media of the present disclosure (referred to herein as the “disclosed application”) can facilitate easy clipping and sharing of various types of media with other users. Users can select a segment of the media, add content to the media, and share the segment with the additional content publicly or privately (e.g., with all users or with limited followers). The additional content can include text, an image, a time, a date, a location, an event, and/or tag(s) to another user, although not limited thereto. The segment can have a predetermined maximum length, which can be selected or clipped by the user, and the user can be prevented from selecting a clip larger than the maximum length. Media can include an audio file (e.g., music, audio book, voice note, etc.) and/or a video file (e.g., a movie, a TV show, etc.), although not limited thereto. The user can share the clipped segment combined with the additional content (referred to herein as a “snip”) with other users, who can comment on, favorite and/or share the combined segment and content.

The disclosed application can be executed using a software application that can be run on an operating system of a computer (e.g., OS X, Microsoft Windows, Linux, etc.), or an operating system of a mobile device (e.g., iOS, Android, Windows Phone, BlackBerry OS, etc.), or using an online application that can be executed through a browser (e.g., Internet Explorer, Firefox, Chrome, Safari, etc.), although not limited thereto. If the disclosed application is executed on a mobile device, it can be downloaded from an online application store (e.g., App Store or Google Play, etc.). Once the application has been downloaded, the user can clip various types of media, add various types of content to the media, and share the combination with one or more users.

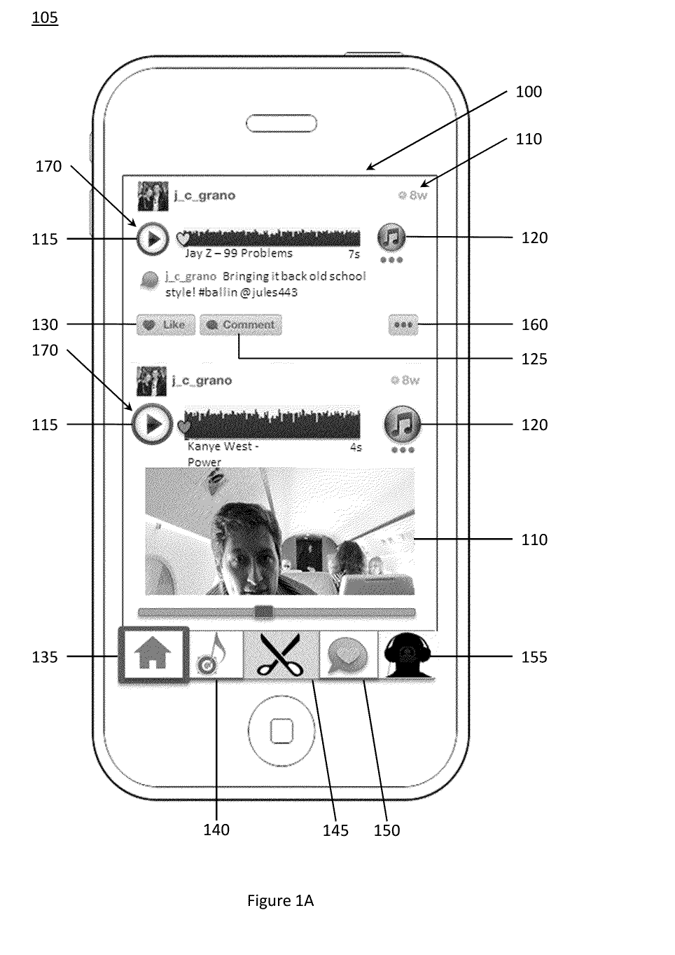

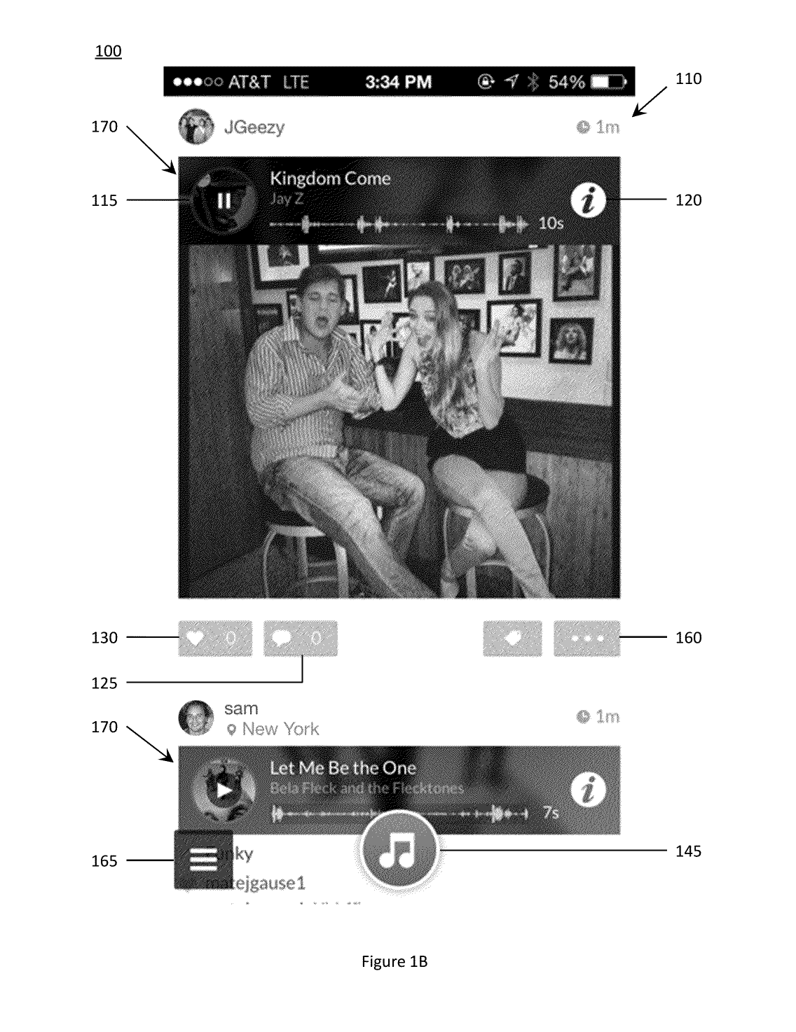

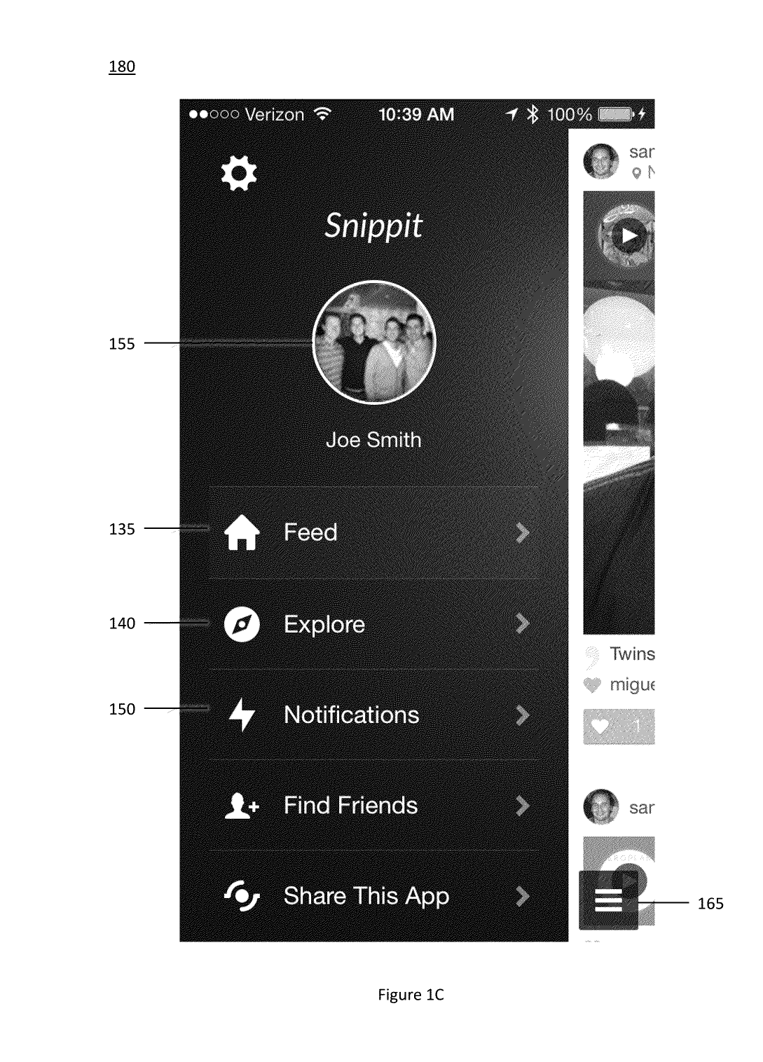

FIG. 1A illustrates a home screen 100 of an exemplary embodiment of the disclosed application. FIGS. 1B and 1C illustrate a home screen 100 of another exemplary embodiment of the disclosed application. As shown, the disclosed application can be run as a standalone application executed on a mobile device 105. When the user activates the disclosed application (e.g., by tapping an applicable icon), a home screen 100 can be displayed. In an exemplary embodiment, the home screen 100 comprises a content feed 110 having a dynamic stream of snips 170 and at least one icon configured to navigate to a respective area of the disclosed application. According to an aspect of the disclosed application, the content feed 110 is configured to display at least one snip 170 and to scroll the dynamic stream of snips for display in the content feed 110.

The at least one icon can include a menu icon 165 for navigation to a menu screen 180; a home icon 135 for navigation to the home screen 100; an explore icon 140 for navigation to an explore screen 300; a create icon 145 for navigation to a create screen 500 for generating a snip; a notification icon 150 for navigation to a content notification feed related to snips that the user interacted with; and a profile icon 155 for navigation to a profile screen 400 of a user, wherein the user can view his/her profile and modify the settings of his/her account. According to an embodiment of the disclosed application, the one or more icons are located at the bottom of the screen as illustrated in FIG. 1A. In another exemplary embodiment of the disclosed application, the home screen 100 comprises a menu icon 165 for navigation to a menu screen 180, wherein the menu screen 180 includes icons for navigation to respective area(s) of the disclosed application (e.g., a home icon 135, an explore icon 140, a notification icon 150, etc.).

According to an exemplary embodiment of the disclosed application, each snip comprises at least one of a favorite icon 130, a comment icon 125, an action icon 160, a play icon 115, and an info icon 120. The info icon 120 is generally configured to display an information screen 800 with respect to the audio or video clip of the snip 170. The favorite icon 130 facilitates a public display of user “favorites” of the respective snip. A user can select the favorite icon 130 of the respective snip to indicate to other users that he or she favors the snip. The comment icon 125 facilitates a process to create and post a comment to the respective snip. A user can select the comment icon 125 to create and post a comment to the respective snip. Furthermore, a user can select the comment icon 125 to create and post a comment in response to a previous comment to the respective snip.

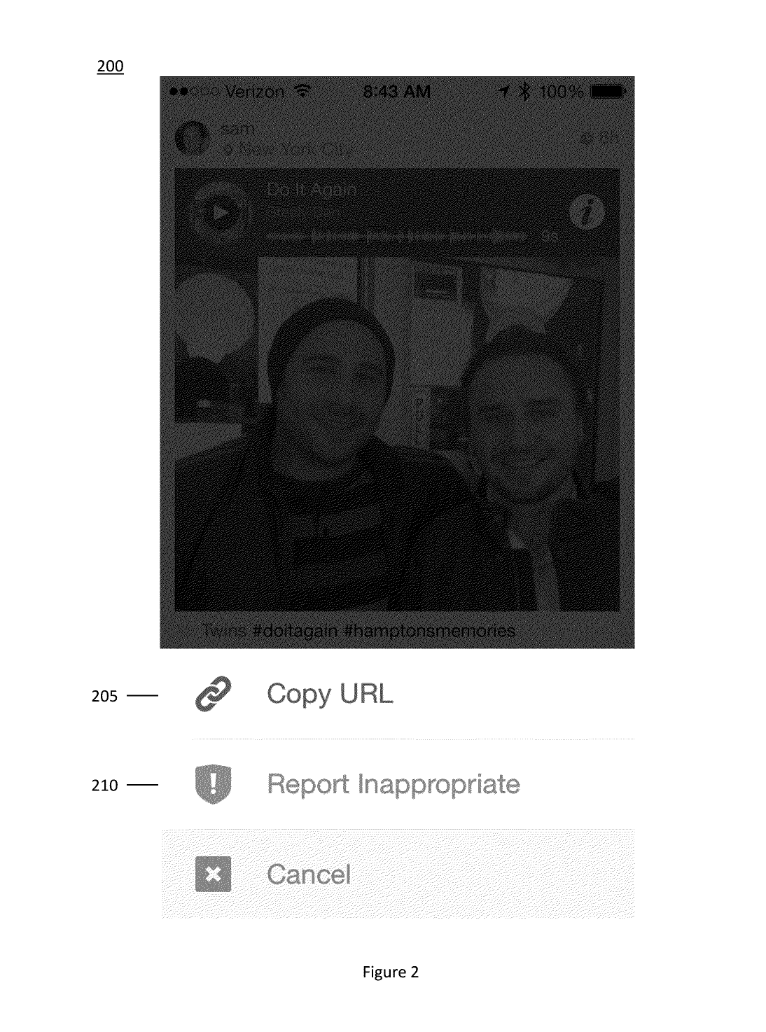

The action icon 160 facilitates the display of a predetermined set of actions as illustrated in FIG. 2. The set of actions generally includes a combination of actions that a user can select with respect to the snip. For example, actions may include reporting inappropriate content of a snip 210, creating and/or copying a link to share the snip on other services 205, and sharing the snip through directly connected third-party services.

The play icon 115 is configured to play an audio or video clip of the respective snip. If the snip is an audio snip, then selecting a particular snip will play the audio clip from the snip as well as display the additional content. If the snip is a video snip, then selecting a particular snip will play the video clip from the snip as well as display the additional content. The audio or video clip can be played automatically once a snip is selected, or selecting a snip can bring up the particular snip, and the user can manually play the audio or video clip. Although the following aspects refer to only an audio clip of the Snip, it is understood that the disclosed aspects pertain to both an audio clip and a video clip of the Snip.

Selection of the play icon 115 commences a playing of the audio clip. In an aspect of the disclosed application, selection of the play icon 115 commences the playing of one incidence of the audio clip. In another aspect, selection of the play icon 115 commences a looping of the audio clip. The looping continues until the occurrence of a termination act. The termination act can include a subsequent selection of the play icon 115 of the looping snip; a selection of a play icon on another snip 175; a scrolling of the display screen wherein the looping snip exits a predetermined area of the display screen (e.g., an area equal in size to one snip 170, with or without an image, and docked at either of the top, middle, or bottom of the display screen); a scrolling of the display screen wherein the looping snip exits the display screen entirely; an exiting of the App on the display screen, including an indirect exiting caused by an opening of a different application or an incoming communication; or an idle status or power off of the mobile device.

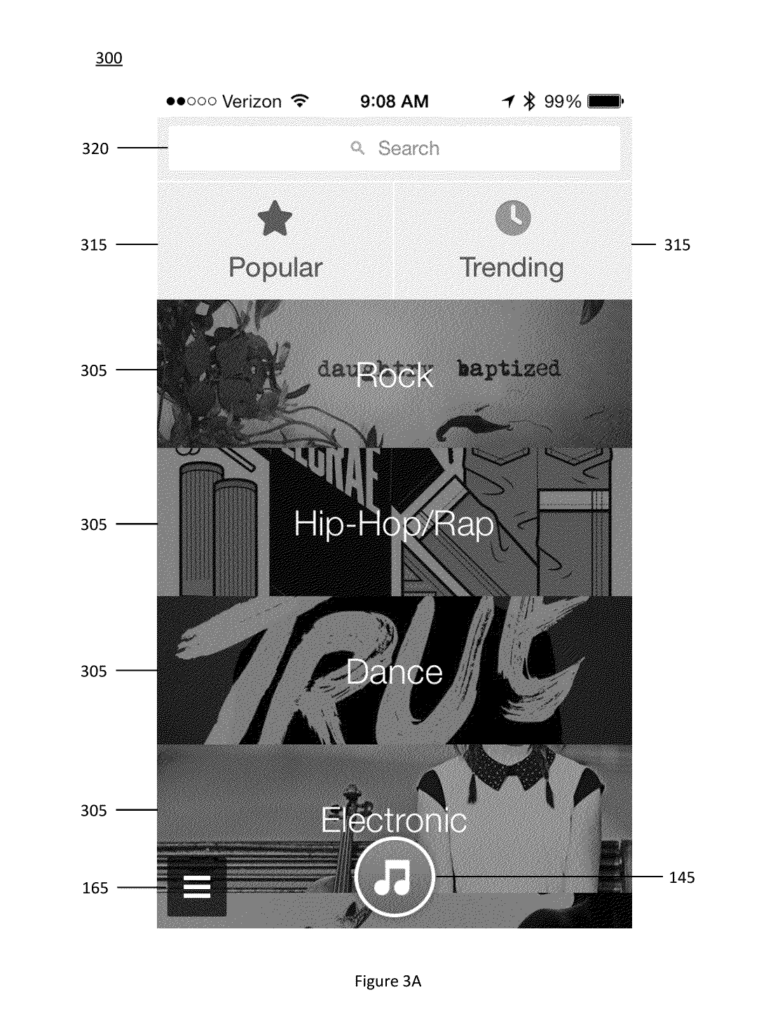

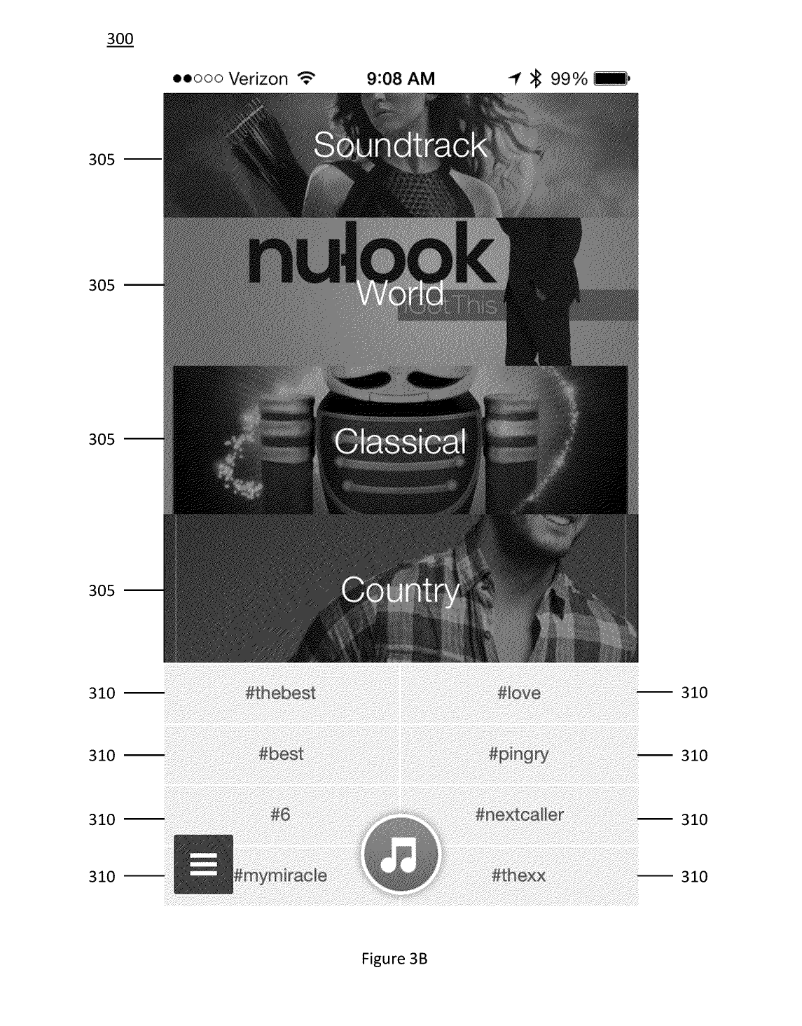

FIGS. 3A and 3B each illustrate a portion of an explore screen 300 of an exemplary embodiment of the disclosed application. The explore icon 140 generally navigates to an explore screen 300. The explore screen 300 enables content exploration by a user and, in particular, to explore targeted content and search 320 for snips and user profiles. In an exemplary embodiment of the disclosed application, the explore screen 300 can display an explore menu having at least one portal icon 305, 310, 315, each of the at least one portal icon having an identified portal theme. For example, a portal theme can be associated with the audio or video clip of snips 305, such as an individual genre, a time period, an artist or a locale, as well as associated with other content of snips 310, such as an image, a location or an identified set of text in the caption. Furthermore, a portal theme can be associated with other data 315 associated with, the snips related to popularity and trends. For example, the popularity of snips can be identified by the number of likes, shares, comments or views. When a respective portal icon is selected, the portal icon generally navigates the display screen to a respective portal feed, the portal feed comprising a content stream having snips associated with the portal theme. The portal feed can further comprise a set of sorting icons. For example, the sorting icons may be configured to sort the respective content stream by a factor, such as the time a snip was generated or posted, or based on popularity.

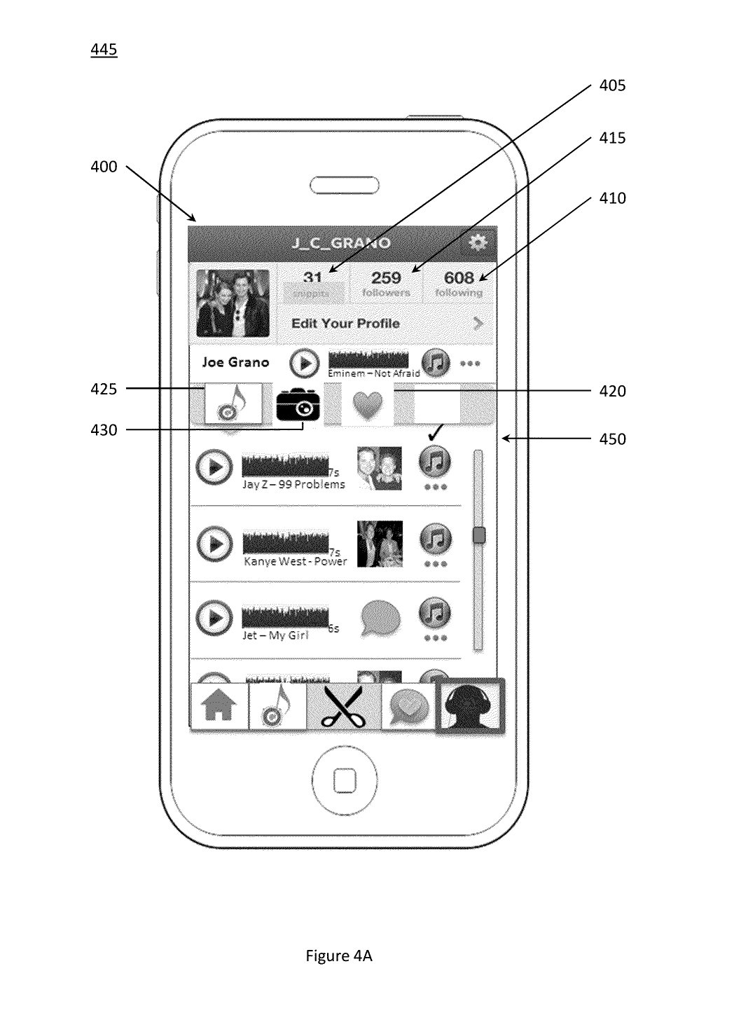

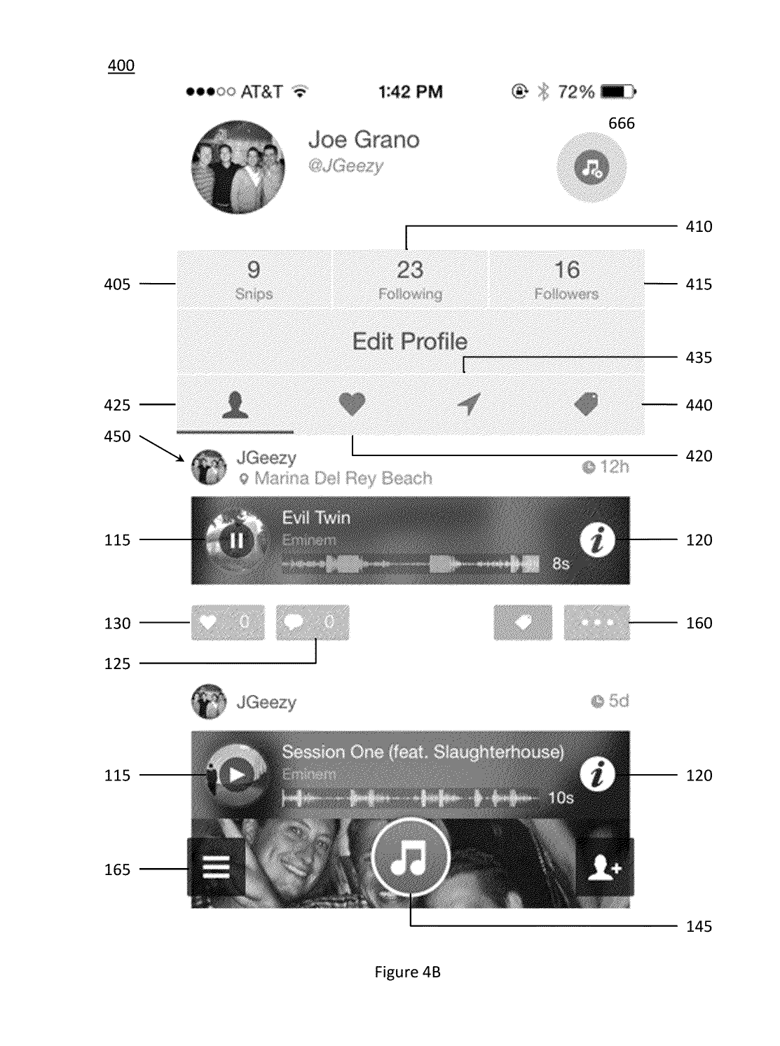

If the user selects or taps the profile icon 155, the disclosed application generally navigates to the profile screen 400 of the user, wherein the user can view the content and information of the profile. For example, the profile screen 400 can display the number of snips created by the user (element 405), the number of followers of the user (element 410), and/or the number of other users the user is following (element 415). Additionally, profile screen 400 can include a profile feed 450 comprising a content stream having snips associated with the user. The profile screen 400 can further comprise a set of sorting icons for the content stream. For example, the sorting icons can include a user icon 425 to display snips posted or shared by the user, a favorite icon 420 to display snips the user has selected as favorites, a location icon 435 to display snips with a location tag, and a tag icon 440 to display snips in which the user is tagged. In an aspect of the disclosed application, a view icon 430 can alter the display of snips in the profile feed 450 between a large format displaying all of the content from each snip and a list format as illustrated in FIG. 4A.

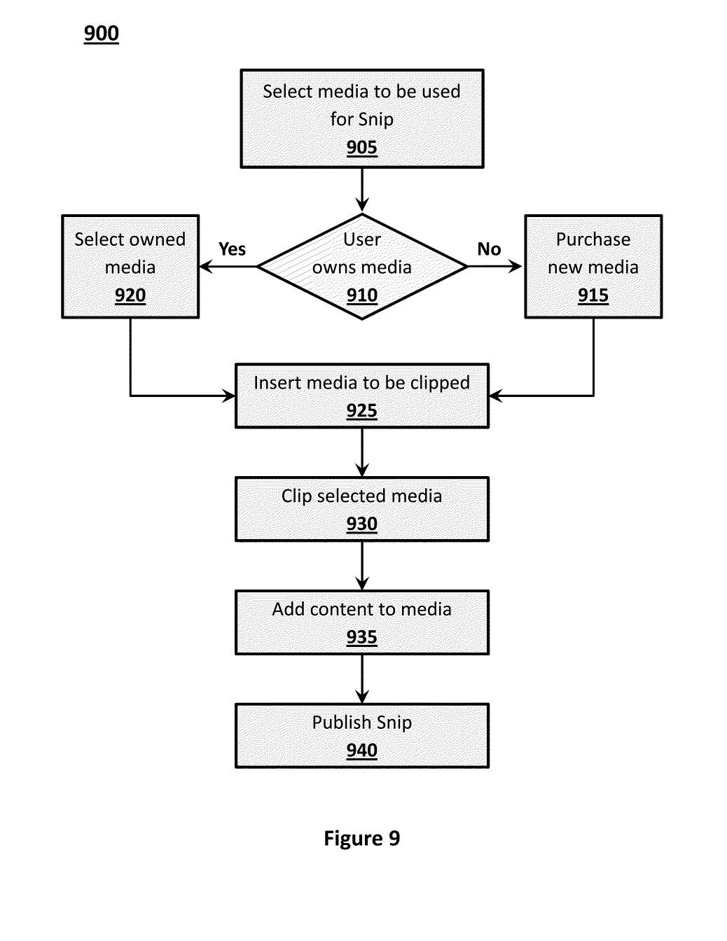

In order to create a new snip, the user can select the create icon 145, which can be located only on home screen 100, or which can be located on some or all of the screens (e.g., home screen 100, menu screen 180, explore screen 300 and profile screen 400). When the user taps or selects the create icon 145, the display screen generally navigates to the create screen 500 to create a new snip (exemplary process 900 of FIG. 9). Here, a user can select the media (e.g., audio or video) to use as the basis of the snip (step 905 of FIG. 9).

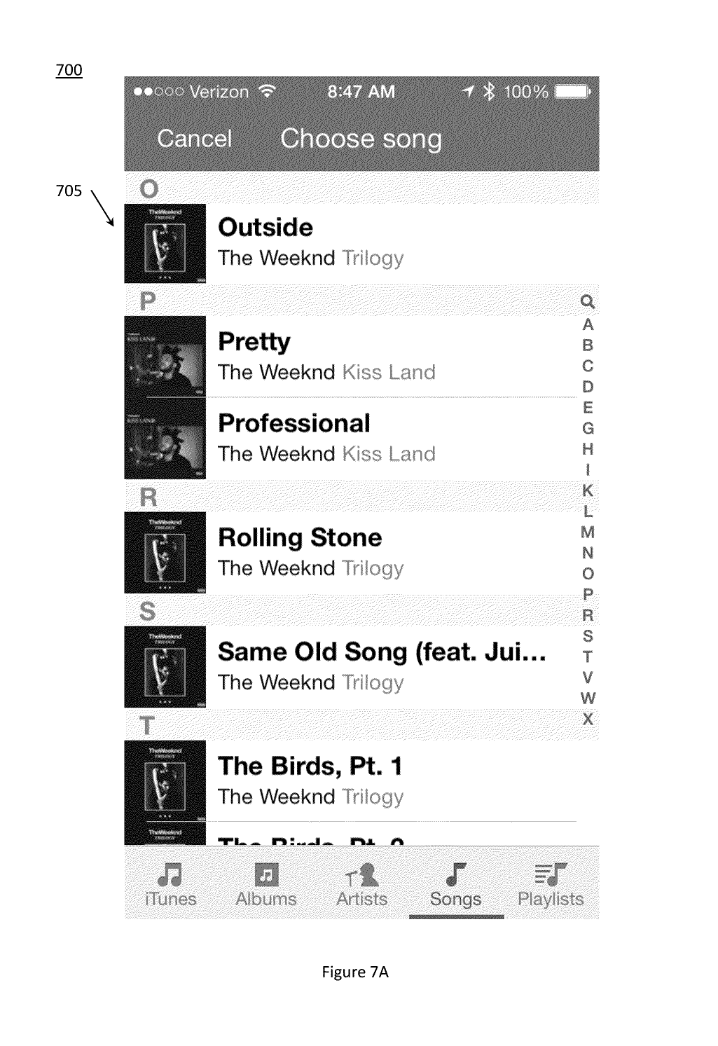

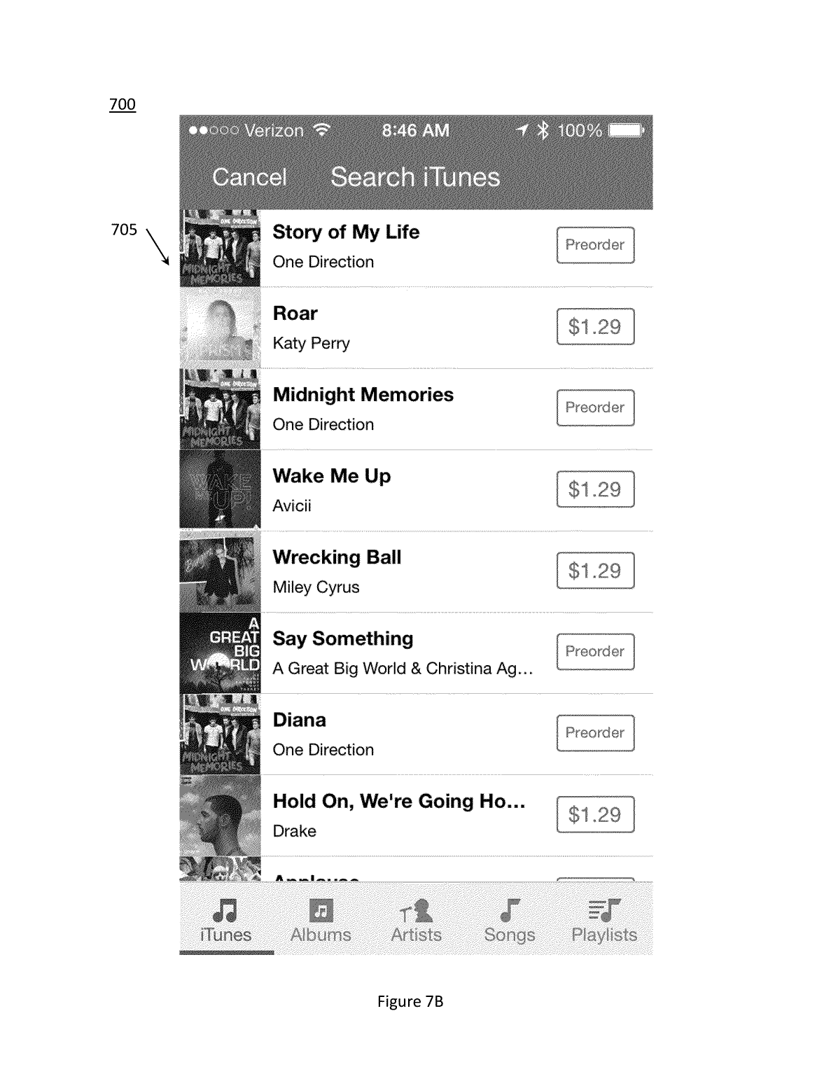

According to an aspect of the present application, when the user selects the create icon 145, and before navigation to the create screen 500, a selection screen 700 enables a user option to select a digital file from a list, as illustrated in FIGS. 7A and 7B. The list of available digital files 705 can include all digital files stored on the computer or mobile device, or a list of digital files stored remotely in the cloud (see FIG. 7A). Alternatively, the list of available digital files 705 can include digital media files available for purchase through an online store (e.g., the iTunes store) (see FIG. 7B). The selection screen 700 can further comprise a search feature using a file explorer. Once the file is selected (e.g., audio file or video file), the display screen generally navigates to the create screen 500. According to another aspect of the present application, the display screen navigates directly to the create screen 500, wherein the create screen includes a select media icon 570 for selection of a digital file. The user can verify that the file being inserted is correct using a display bar 565, which displays the title and artist of the selected digital file.

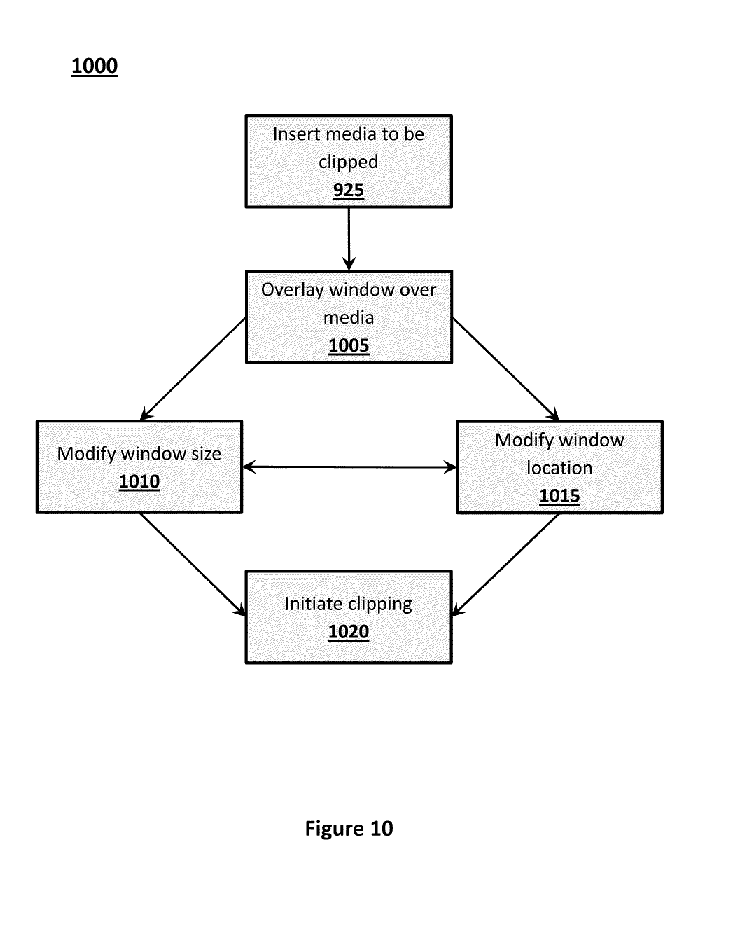

The user can insert content that the user purchased, or that is available for access by the user. For example, at step 910 of FIG. 9, the user can opt to include media previously purchased or to purchase new media for insertion therein. In the case of previously purchased media (step 920 of FIG. 9), the user can select media from the media stored on the computer or mobile device, or media stored in a cloud storage of the user. For example, the media can be selected from the device's digital library, the iTunes account of the user, or a cloud account for digital storage. Alternatively, the user can purchase media through the disclosed application, which can direct the user to an online music store (e.g., iTunes), and the user can purchase the media to be used (step 915 of FIG. 9). If a user purchases the media, then the media can be made available to the user outside of the disclosed application. Revenue can be generated by a referral fee paid by the online media store if the user buys the media from the online media store through a referral by the disclosed application. After the media has been selected, the user can clip the selected media (process 1000 of FIG. 10).

Once the media file is inserted into the create screen 500 (step 925 of FIG. 9), a waveform 520 of the particular file can be displayed. The waveform 520 can further be displayed with a time display 515, which can show the time range of the portion of the waveform that is being displayed. Overlaid over the waveform 520 can be a window 525 (step 1005 of FIG. 10). A window 525 can define a length of time to be clipped from the media file. According to an aspect of the disclosed application, the window 525 can have a predetermined maximum amount of time that can be clipped (e.g., 1 second, 2 seconds, 5 seconds and 10 seconds up to the entire duration of the media). The maximum time can be automatically set for the user such that the user does not have the ability to modify the maximum time. Alternatively, the user can set the maximum time as an option in the application settings. While the maximum time can be automatically set for the user, the user may be provided with an ability to modify the time interval to any amount of time smaller than the maximum time (step 1010 of FIG. 10). For example, if the maximum time is 10 seconds, the user may have the ability to modify the window to be any amount of time greater than 0 seconds and no more than 10 seconds.

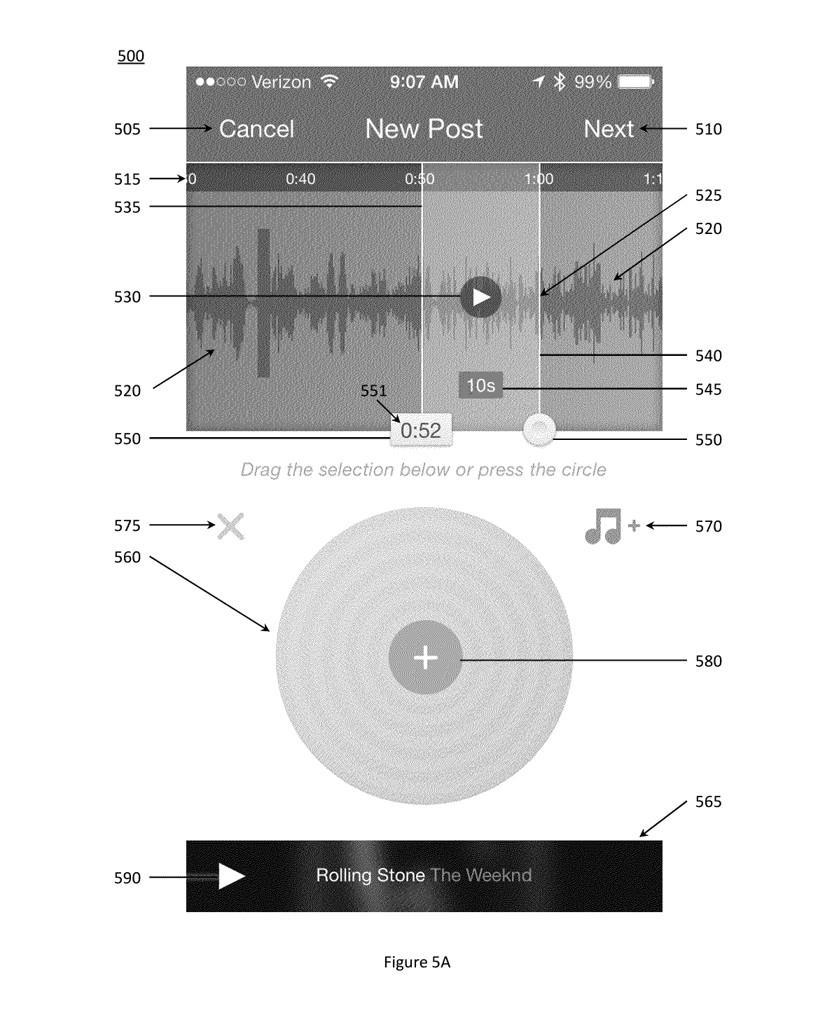

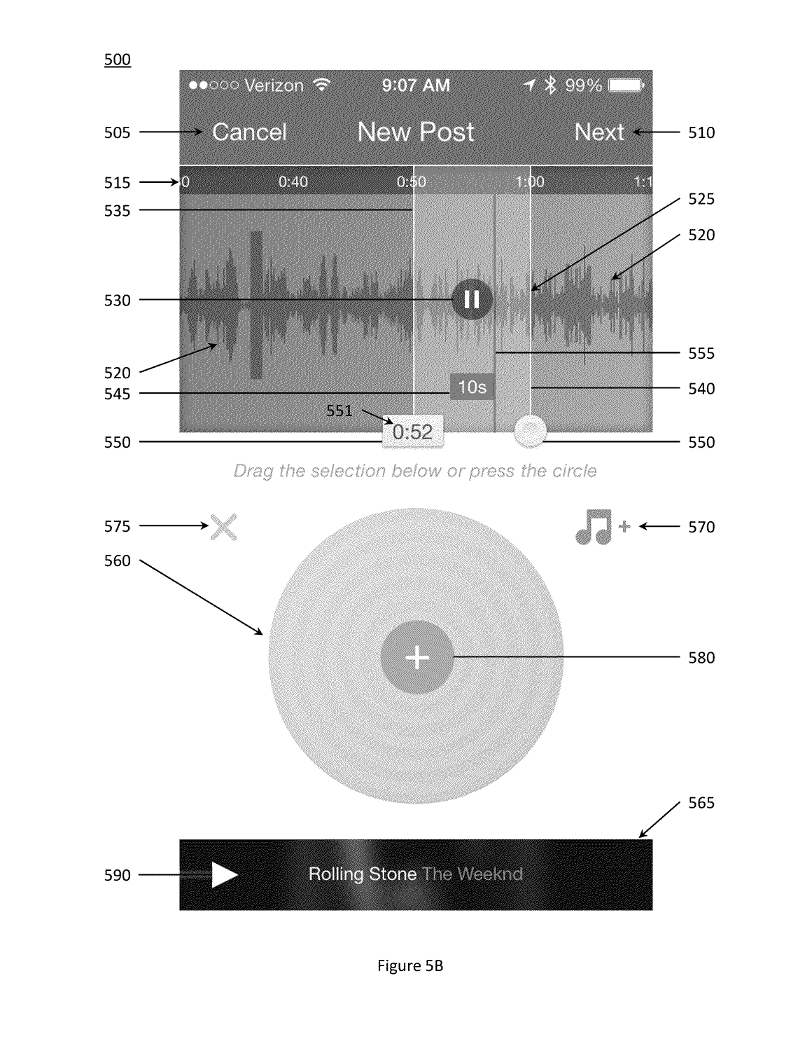

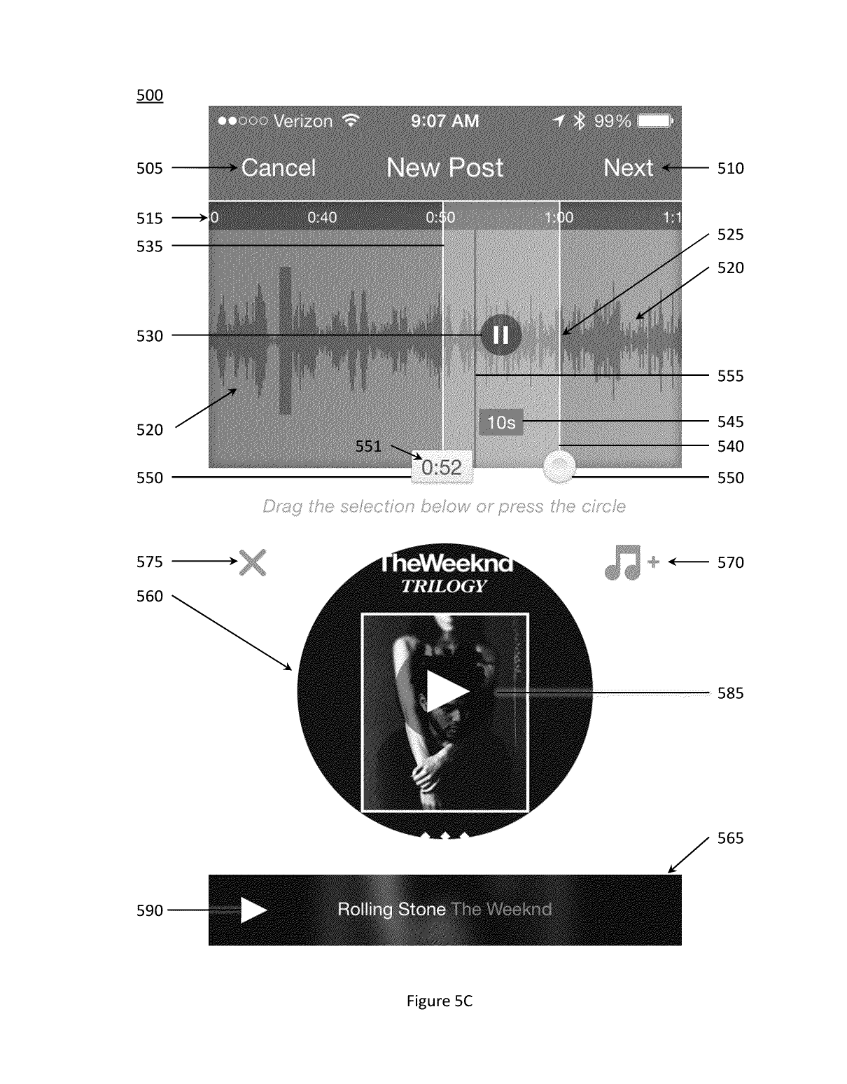

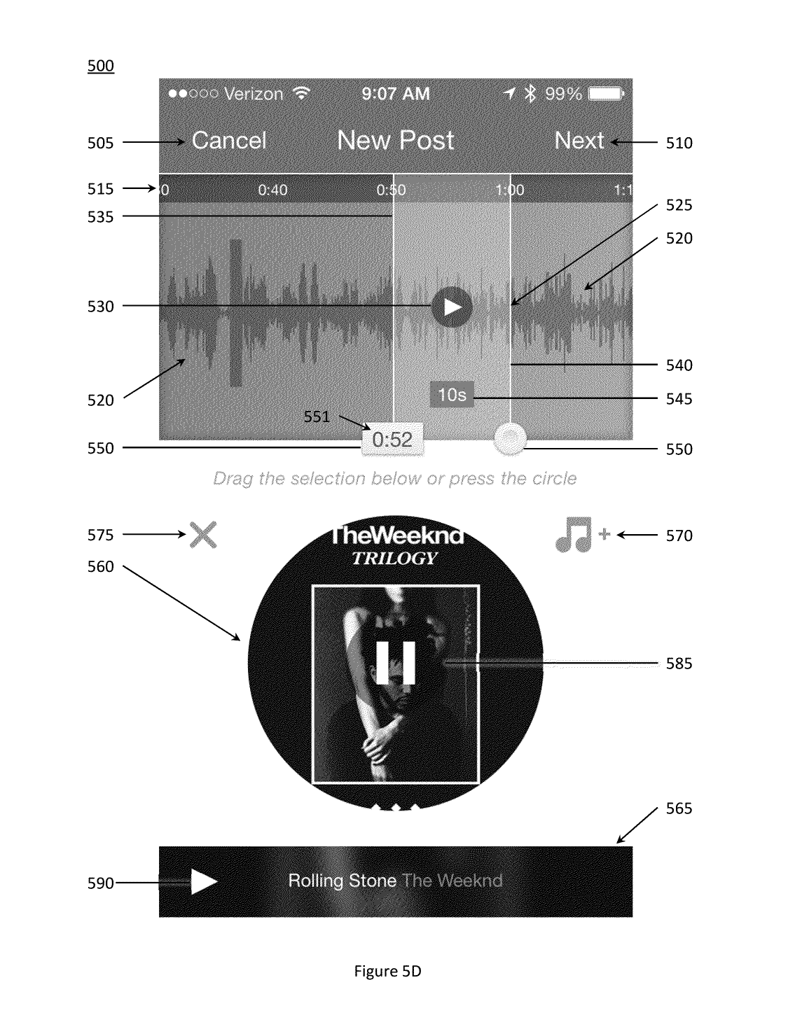

With reference to FIGS. 5A-5D, the current time interval for window 525 is illustrated by a time interval display 545, and the boundaries of window 525 are illustrated by a first edge 535 and a second edge 540. The user can move the window 525 in its entirety by selecting anywhere inside of the window 525, and dragging the window 525 to the right or left (step 1015 of FIG. 10). The user can also make the window 525 larger or smaller using a slider 550, which can be located on one or both of the first edge 535 and the second edge 540. The user can see the start time 551 of the window 525 at the slider 550 of the first edge 535. The user can manipulate both the length of the time interval defined by the window 525 and position of the window 525. For example, the user can modify the time interval of the window 525 and then modify the position of the window 525, and then further modify the time interval of the window 525 after the position of the window 525 has been modified.

According to an exemplary embodiment of the disclosed application, the create screen 500 further comprises a play icon 590 configured to play the entirety of the media file or a portion thereof. FIGS. 5A-5D illustrate the play icon 590 within the display bar 565. In another aspect, the play icon 590 can be displayed on or within other elements of the create screen 500. For example, without limitation, the play icon 590 can be displayed on or as part of the waveform 520 or the time display 515. The play icon 590 enables the user to play the media and to locate a portion or starting point of the media to clip. When the play icon 590 is selected, a play bar 555 moves across the waveform 520 to indicate a precise location of the playing with respect to the graphic display that represents the media and, in particular, the waveform 520. Furthermore, the play bar 555 functions in combination with the time display 515 to indicate a precise time of a playing with respect to the temporal count and/or length of the media.

FIGS. 5B and 5C illustrate the play bar 555 in a location within the window 525 in view of a selection of the play icon 530. The play bar 555 can move outside the window 525 in the case of a selection of the play icon 590 (configured to play the entirety of the media) in contrast to the play icon 530 (configured to play a portion of the media defined by the window 525). When selected, the play icon 590 can transition to a pause icon configured to pause the playing of the media upon a subsequent selection. When playing of the media is paused, the user can drag the play bar 555 across the graphic display or waveform 520 in either direction to select a starting point to play upon selection of the play icon 590. According to another aspect, upon a selection of the play icon 590, while the media is playing, the user can drag the play bar 555 across the waveform 520 in either direction to “skip” within the media (i.e., to manipulate the temporal location of the playing) without pausing the media.

After the window 525 has been positioned to define a respective clip of the media file, the user can preview the clip by selecting a play icon 530 of the window 525, which will play the audio or video file (see FIG. 5A). When the play icon 530 is selected, the selected portion of the media file commences. The play icon 530 can transition to a pause icon when the media is playing (see FIGS. 5B and 5C). The play bar 555 can move from the first edge 535 to the second edge 540 to indicate the precise time of the media being played with respect to both the entire media file and the window 525.

If at any time the user wants to cancel the creation of the Snip, the user can select a cancel icon 505. The cancel icon 505 can navigate to the display screen shown when the user selects the create icon 145 (e.g., the media selection screen 700), to the home screen 100, or to a previous screen displayed for the user. If the user wants to insert a new media file, the user can select the cancel icon 505 and then reselect the create icon 145. Alternatively, the user can select the select media icon 570 to select a new media file to clip.

After the user has selected the particular window to be clipped, the user can drag the window 525 on the display screen to an insertion area 560 to isolate the selected clip from the entire media file. To drag the window on the screen, the user places the appropriate tool (e.g., a finger, mouse pointing device, or stylus) and drags the tool on the screen towards the insertion area 560. Alternatively, the user can tap an insert icon 580 in the insertion area 560 to isolate the clip defined by the window 525 in the insertion area 560 (e.g., step 930 from FIG. 9 and step 1020 of FIG. 10). Once the clip has been isolated in the insertion area 560, the user can select the next icon 565 to navigate to an add content screen 600. Alternatively, prior to selecting the next icon 565, the user can select the play icon 585 of the insertion area 560 to play the clip captured in the insertion area 560, as shown in FIG. 5C. The play icon 585 can transition to a pause icon when the media is playing (see FIGS. 5C and 5D). The user can adjust the window 525, as well as play a new selection of the media by selecting the play icon 530 of the window 525, without altering the media clip captured in the insertion area 560. The user can remove the media clip captured in the insertion area 560 by selecting a remove icon 575.

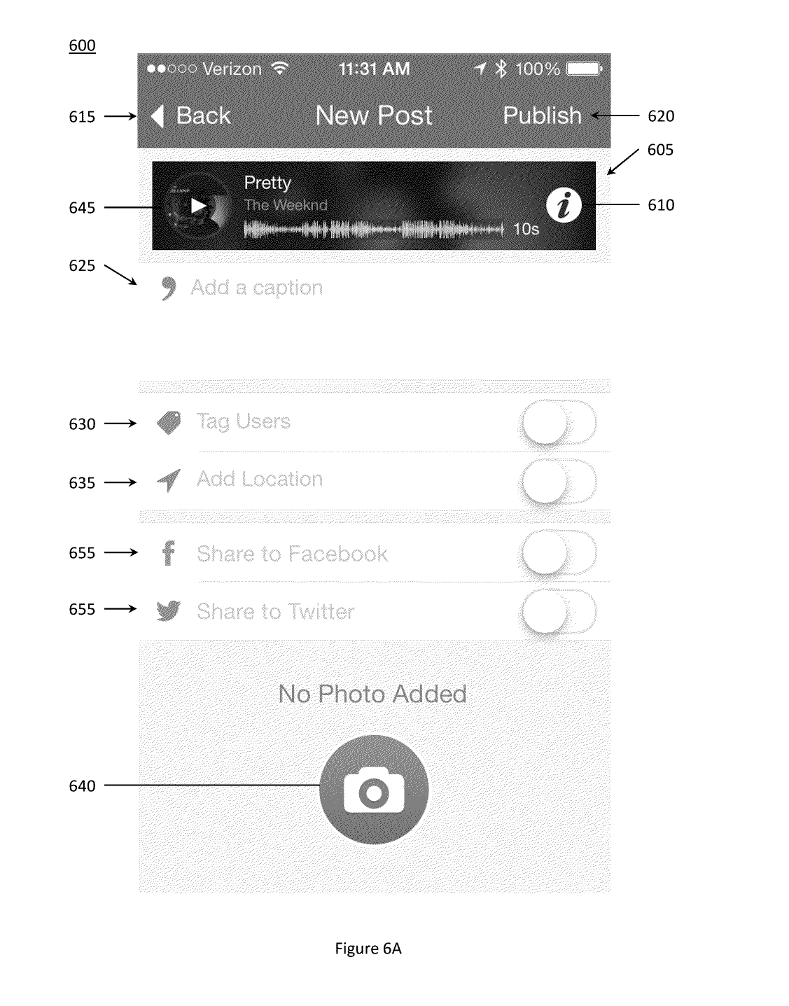

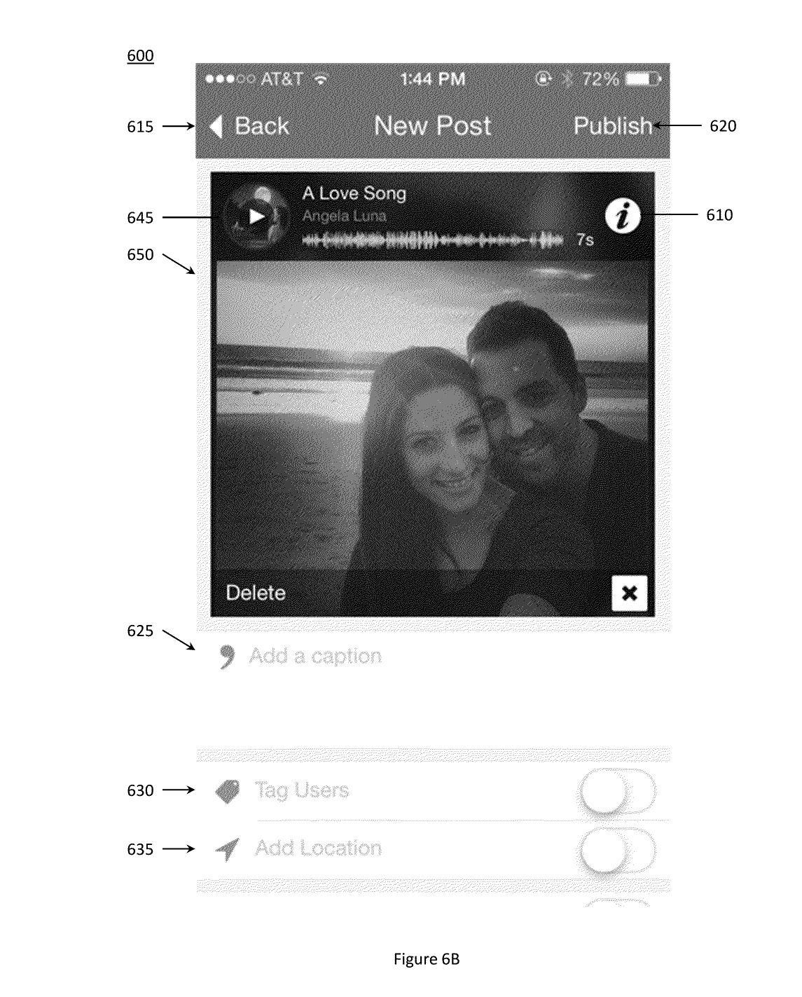

On the add content screen 600, the user can view the selected media clip 605, play the selected media clip using the play icon 645, and view information about the media using the info icon 610, which will be detailed below. The add content screen 600 gives the user the option to add various types of content to the clipped media (step 935 of FIG. 9). For example, users can add a caption 625, which can include a description about the content, or any other text-based content. The caption 625 can be limited in the number of characters, or an unlimited number of characters may be used. A user can also add an image 640. When an image is added, the image 650 can be displayed below the clipped media as shown in FIG. 6B. Users can also tag a location 635 in the snip (e.g., the location of the user when the snip is posted to the platform), and tag one or more users 630 in the snip (e.g., users in the photo, followers of the user, or any other users). Various other content can be added, including audio files if the clipped media is a video, video files if the clipped media is an audio file, and emoticons, although not limited thereto. The user can also select where to share the snip once published 655. For example, the user may choose to share the snip on other networks, as shown in FIG. 6A. At any time, the user can select the back icon 615 to navigate back to the create screen 500. After a user has finished adding content, the user can select the publish icon 620 (step 940 of FIG. 9). If no content is added at the add content screen 600, the disclosed application may prevent the publication of the snip. For example, the disclosed application can require that at least one content be added to the clipped media, or at least one particular type of content be added to the media.

Once a snip is published, it can be publicly available. For example, the snip can be available to all users of the disclosed application, as well as other individuals who access the snip through third party applications or browsers. Alternatively, the snip can be available only to registered users of the application or to the user's followers or another preselected group of users. Viewers of the snip can view the content, and play the clipped media. Users can also add a comment to the snip that is available to all users with access to the snip. Alternatively, users can send a comment directly to the creator of the snip, which is only viewable by the creator of the snip.

If a person viewing the snip selects the info icon 610, the disclosed application generally displays information screen 800. The information screen 800 can display information with respect to the media clip of the snip. For example, if the media clip is a song, the information screen 800 can display the album art 815 and/or album information 820, including the artist, title, album and year of release of the album. In another aspect, the information screen further includes a purchase link 825 configured to navigate the display screen to another application. In particular, the purchase link 825 can navigate to an online store (e.g., the iTunes store or the Google Play store) for purchasing the content identified on the information screen 800.

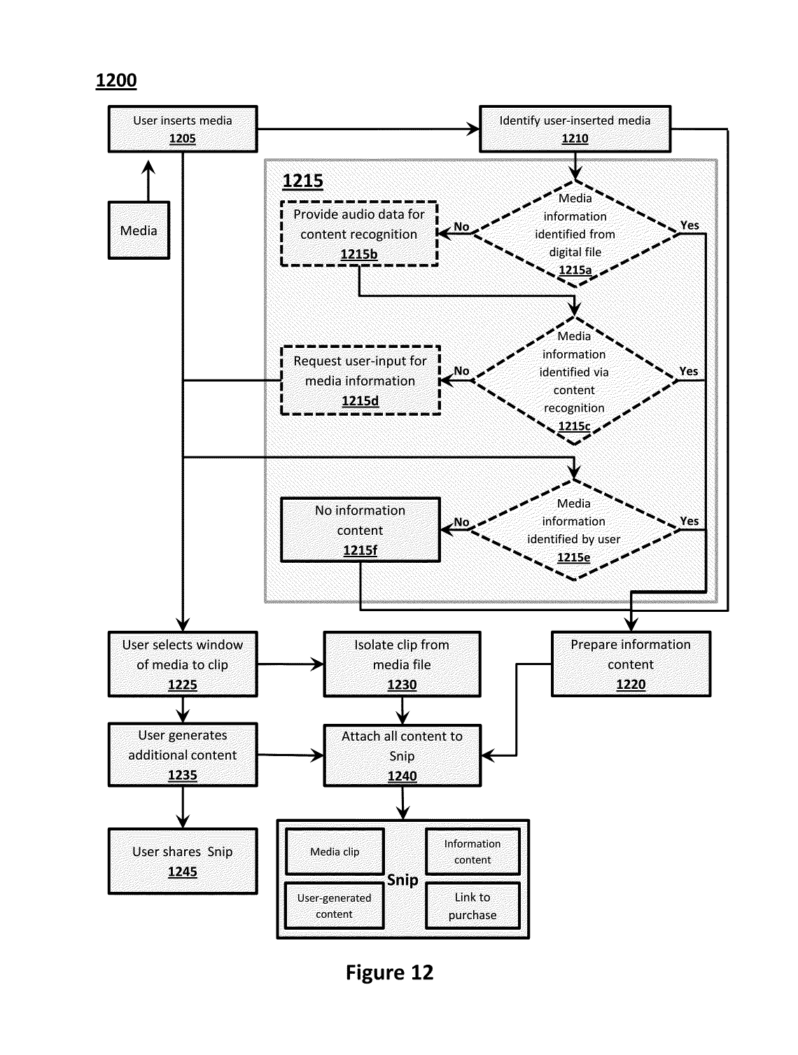

FIG. 12 shows a flow chart of a process for creating a snip 1200 according to an exemplary embodiment of the disclosed application. When a user inserts media 1205, the system can automatically generate the information for display on the information screen 800 (FIG. 12, exemplary process 1215). The system can identify content information for the user-inserted media 1210 from a digital file or metadata of the media clip 1215b. Alternatively, if the content information is not identified in the media file, the system can provide audio data for content recognition to an external database 1215b, or request user-input of content information 1215d. If the content information is identified (1215a, 1214c, 1215e), or if the system does not identify any content information 1215f, the identified information, if any, can be prepared for inclusion in the snip 1220. The generation of information can occur at the time of creation of the snip. In another aspect, the generation of information can occur at the time of selection of the info icon 120, wherein a music identification service compares the sample of audio (i.e., the audio or video clip of a snip) to a database and, if a match is identified, relays the information for the match to the disclosed application.

The aspects of the info icon 120 and the information screen 800, including the purchase link 825, in combination, identify content in a snip, provide that content information on a display screen at the request of a user, and direct the mobile device or computer to an online store for purchasing the identified content. Revenue for the disclosed application can be generated through such a referral. For example, revenue can be generated when a person simply selects the purchase link 825, even if the person does not buy the media. Additional revenue can be generated if the user actually purchases the media. Alternatively, revenue may only be generated if the person actually purchases the media. Thus, the disclosed application can function as (1) a forum to share content; (2) a music discovery service; and (3) a source of revenue through referral fees.

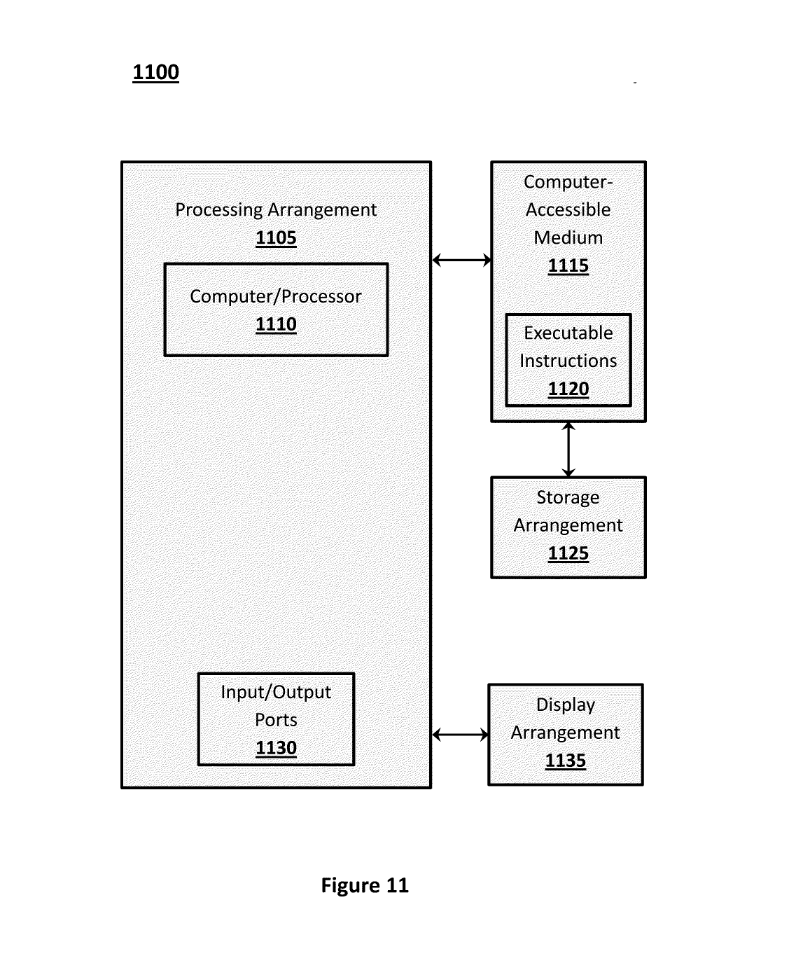

FIG. 11 shows a block diagram of an exemplary embodiment of a system according to the present disclosure. For example, exemplary procedures in accordance with the present disclosure described herein can be performed by a processing arrangement and/or a computing arrangement 1105. Such processing/computing arrangement 1105 can be, for example, entirely or a part of, or include, but not limited to, a computer/processor 1110 that can include, for example, one or more microprocessors, and use instructions stored on a computer-accessible medium (e.g., RAM, ROM, hard drive, or other storage device).

As shown in FIG. 11, for example, a computer-accessible medium 1115 (e.g., as described herein above, a storage device such as a hard disk, floppy disk, memory stick, CD-ROM, RAM, ROM, etc., or a collection thereof) can be provided (e.g., in communication with the processing arrangement 1105). The computer-accessible medium 1115 can contain executable instructions 1120 thereon. In addition or alternatively, a storage arrangement 1125 can be provided separately from the computer-accessible medium 1115, which can provide the instructions to the processing arrangement 1105 to configure the processing arrangement to execute certain exemplary procedures, processes and methods, as described herein above, for example.

Further, the exemplary processing arrangement 1105 can be provided with or include an input/output arrangement 1130, which can include, for example, a wired network, a wireless network, the internet, an intranet, a data collection probe, a sensor, etc. As shown in FIG. 11, the exemplary processing arrangement 1105 can be in communication with an exemplary display arrangement 1135, which, according to certain exemplary embodiments of the present disclosure, can be a touch-screen configured for inputting information to the processing arrangement in addition to outputting information from the processing arrangement, for example. Further, the exemplary display 1135 and/or a storage arrangement 1125 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. It should be understood that the exemplary procedures described herein can be stored on any computer accessible medium, including a hard drive, RAM, ROM, removable disks, CD-ROM, memory sticks, etc., and executed by a processing arrangement and/or computing arrangement which can be and/or include a hardware processors, microprocessor, mini, macro, mainframe, etc., including a plurality and/or combination thereof. In addition, certain terms used in the present disclosure, including the specification, drawings and numbered paragraphs thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

What is claimed is:

1. A non-transitory computer-accessible medium having stored thereon computer-executable instructions for generating at least one a media clip, wherein, when a computer hardware arrangement executes the instructions, the computer arrangement is configured to perform procedures comprising:
receiving first information related to at least one media;
receiving second information related to a position of a window of time in relation to the at least one media, the window of time having a time interval with a preset maximum time;
receiving third information related to a further position of the window of time based on a movement of the window of time while maintaining the time interval;
generating the at least one media clip based on the second information and the third information.

2. The computer-accessible medium of claim 1, wherein the preset maximum time is about 10 seconds.

3. The computer-accessible medium of claim 1, wherein the at least one media clip is generated by clipping the at least one media based on the time interval and the further position of the window of time.

4. The computer-accessible medium of claim 1, wherein the at least one media is at least one of an audio file or a video file.

5. The computer-accessible medium of claim 1, wherein the computer arrangement is further configured to receive information related to at least one content, and combine the at least one content with the at least one media clip into a single digital file.

6. The computer-accessible medium of claim 5, wherein the at least one content includes at least one of an image, a caption, a location, or a user tag.

7. The computer-accessible medium of claim 5, wherein the computer arrangement is further configured to share the single digital file with a plurality of users.

8. The computer-accessible medium of claim 1, wherein the computer arrangement is further configured to:
receive a request for information pertaining to the at least one media clip; and
direct the request to at least one online store where the at least one media can be purchased.

9. The computer-accessible medium of claim 8, wherein the computer arrangement is further configured to receive a monetary credit for directing the request to the at least one online store.

10. The computer-accessible medium of claim 8, wherein the computer arrangement is further configured to receive a monetary credit if the at least one media is purchased from the at least one online store.

11. A non-transitory computer-accessible medium having stored thereon computer-executable instructions for receiving a monetary credit wherein, when a computer hardware arrangement executes the instructions, the computer arrangement is configured to perform procedures comprising:
receiving first information related to at least one media;
receiving second information related to a portion of the at least one media;
receiving a request for information pertaining to the portion of the at least one media;
directing the request to at least one online store where the at least one media can be purchased; and
receiving a monetary credit from the at least one online store.

12. The computer-accessible medium of claim 11, wherein the computer arrangement is further configured to receive a monetary credit for at least one of directing the request to the at least one online store or if the at least one media is purchased from the at least one online store.

13. A method for generating at least one media clip, comprising:
receiving first information related to at least one media;
receiving second information related to a position of a window of time in relation to the at least one media, the window of time having a time interval with a preset maximum time;
receiving third information related to a further position of the window of time based on a movement of the window of time while maintaining the time interval;
using a computer hardware arrangement, generating the at least one media clip based on the second information and the third information.

14. The method of claim 13, wherein the preset maximum time is about 10 seconds.

15. The method of claim 13, wherein the at least one media clip is generated by clipping the at least one media based on the time interval and the further position of the window of time.

16. A method for receiving a monetary credit, comprising:
receiving first information related to at least one media;
receiving second information related to a portion of the at least one media;
receiving a request for information pertaining to the portion of the at least one media;
directing the request to at least one online store where the at least one media can be purchased; and
using a computer hardware arrangement, receiving a monetary credit from the at least one online store.

17. The method of claim 16, wherein the receiving of the monetary credit includes receiving a monetary credit for at least one of directing the request to the at least one online store or if the at least one media is purchased from the at least one online store.

18. A system for generating at least one a media clip, comprising:
a computer hardware arrangement configured to:
receive first information related to at least one media;
receive second information related to a position of a window of time in relation to the at least one media, the window of time having a time interval with a preset maximum time;
receive third information related to a further position of the window of time based on a movement of the window of time while maintaining the time interval;
generate the at least one media clip based on the second information and the third information.

19. The system of claim 18, wherein the preset maximum time is about 10 seconds.

20. The system of claim 18, wherein the computer hardware arrangement is further configured to generate the at least one media clip by clipping the at least one media based on the time interval and the further position of the window of time.

21. The system of claim 18, further comprising directing a request to at least one online store where the at least one media can be purchased; and receiving a monetary credit from the at least one online store.
